(19) United States
(12) Patent Application Publication
(10) Pub. No.: US 2017/0188301 A1
(43) Pub. Date: Jun. 29, 2017

(54) System, method and apparatus for backward compatible power reduction FTM responders

(71) Applicant: Intel IP Corporation, Santa Clara, CA (US)

(72) Inventors: Elad Eyal, Shoham (IL); Jonathan Segev, Tel Mond (IL)

(73) Assignee: Intel IP Corporation, Santa Clara, CA (US)

(21) Appl. No.: 14/998,293

(22) Filed: Dec. 24, 2015

(51) Int. Cl. H04W 52/02; H04W 56/00; H04W 4/02

(52) U.S. Cl. CPC H04W 52/0209; H04W 4/02; H04W 56/001

(57) ABSTRACT

The disclosure generally relates FTM measurements using a network of Access Points (APs) and FTM Responders to provide proximity information to an inquiring mobile device. In one embodiment, the disclosure provides significant power conservation by allowing an AP to communicate with the user equipment (e.g., mobile device). The AP can relay information about availability of an FTM Responder to the user equipment thereby directing the user equipment to transmit its FTM Request directly to the FTM Responder during the Responder's availability window. The disclosed embodiment enable significant power conservation for the FTM Responder thereby extending the battery life of the Responder.

### BACKGROUND

Field

The disclosure generally relates to system, method and apparatus for backward compatible power reduction Fine Timing Measurement (FTM) responders. Specifically, the disclosed embodiments relate to FTM measurements using a network of Access Points (APs) and FTM responders to provide location information to an inquiring mobile device.

Description of Related Art

Accurately locating wireless network devices may incur a computational cost associated with performing numerous location determinations from multiple terrestrial sources. The computational cost may impact other processing activities of a device and also incur additional power consumption, which may degrade performance or usability of the device. Thus, there are general needs for systems and methods to reduce the cost associated with accurately locating a wireless device.

### BRIEF DESCRIPTION OF THE DRAWINGS

The disclosure will be discussed with reference to the following exemplary and non-limiting illustrations, in which like elements are numbered similarly, and where:

FIG. 1A shows a physical layout of an exemplary embodiment of the disclosure;

FIG. 1B shows a logical layout of the exemplary embodiment of the disclosure as shown in FIG. 1A;

FIG. 2 illustrates an exemplary implementation of one embodiment of the disclosure for non-ASAP FTM measurements;

FIG. 3 illustrates an exemplary implementation of one embodiment of the disclosure for ASAP FTM measurements;

FIG. 4 shows an exemplary packet for carrying the scheduling message; and

FIG. 5 shows an exemplary apparatus according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Various techniques and configurations described herein provide location discovery techniques used in conjunction with wireless communications and network communications. The presently described location techniques may be used in conjunction with wireless communication between devices and access points (APs). With some network technologies, establishing the location of a device makes use of Time-of-Flight (ToF) calculations to calculate the distances between the device and multiple access points. For example, a device may request ToF information from two or more APs in order to establish a physical distance from each individual AP. The calculated physical distance may be used to determine an approximate physical location of the device with respect to the APs.

Outdoor navigation is widely deployed thanks to the development of various global-navigation-satellite-systems including GNSS, GPS, etc. The recent focus has been on WLAN 802.11 based indoor navigation. IEEE 802.11 REVmc_D4 (January 2015) standard has developed the Fine Timing Measurement (FTM) procedure which measures the roundtrip signal travel time or ToF. An exemplary method for ToF positioning includes an FTM procedure performed by an initiating station and a responding station. The Wi-Fi Alliance (WFA) is developing a certification program called Wi-Fi Location Certification as well as adding range measurement to its Neighbor Aware Networking protocol. However, these protocols makes an underlying assumption that the Responding STA is continually available to receive and respond to FTM Request frames or that it is available at designated times for such requests. The assumption requires availability of the FTM Responder even if an outstanding request does not exist. Making the FTM Responder continually available is highly inefficient. In one embodiment, the disclosure provides method and systems to reduce the inefficiency.

An FTM session is an instance of an FTM procedure between an initiating STA and a responding STA along with the associated scheduling and operational parameters of that instance. An FTM session includes negotiation, measurement exchange and termination. To support the constraints of both the initiating and responding STAs, during the negotiation phase the initiating STA initially requests a preferred periodic time window allocation. The responding STA subsequently responds by accepting or overriding the allocation request based on its resource availability and capability. Since some of the initiating STA's activities may be nondeterministic and may have higher precedence than the FTM session (e.g., data transfer interaction with an associated AP), a conflict might prevent the initiating STA from being available at the beginning of the burst instance determined by the responding STA. An FTM sessions may be designated with two ASAP settings: ASAP=0 and ASAP=1. For ASAP set to 1, the session indicates the initial FTM frame to also be used, in addition to FTM session allocation, for the purpose of measurement for RTT purposes. For ASAP set to zero, this condition does not hold.

In certain embodiments, the disclosure provides a class of devices referred to as FTM Responders to be deployed such that they augment the connectivity 802.11 WLAN Standard with location capability by implementing the FTM protocol in combination with an AP (i.e., governing AP). In one application, the AP performs assignment and management of the session with the initiating STAs and the FTM responder(s) perform the actual measurements. As a result, the FTM Responders are only made available periodically to minimize the active duty cycle during which the FTM Responder is available.

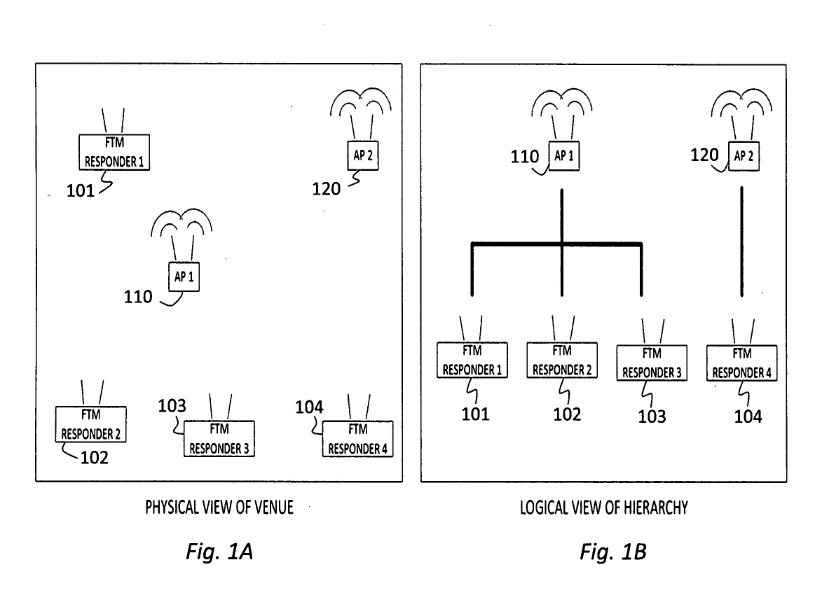

FIG. 1A shows a physical layout of an exemplary embodiment of the disclosure. FIG. 1B shows a logical layout of the exemplary embodiment of the disclosure of FIG. 1A. Referring simultaneously to FIGS. 1A and 1B, the depicted environment includes AP 1 (110) and AP 2 (120). In one embodiment, the APs act as governing APs by receiving communications from a requester or initiating STA (not shown) and arranging FTM procedures between the requester and the FTM Responder(s). An initiating STA may engage the closest AP for conducting an FTM procedure. The FTM procedure may be used by the initiating STA to determine its location or to determine proximity to other devices (i.e., AP or FTM Responders).

The environment also includes Responder 1 (101), Responder 2 (102), Responder 3 (103) and Responder 4 (104). Each Responder may communicate directly with one (or optionally more) APs. In the logical representation of FIG. 1B, Responder 4 (104) communicates with AP 2 (120) and Responders 101, 102 and 103 communicate with AP 1 (110). In certain embodiments, the FTM procedure is divided between the FTM Responders and the governing AP such that the operation is transparent to the initiating STA seeking its location. Each FTM Responder may be responsible to perform time synchronization with its governing AP. Thus, FTM Responders 101, 102 and 103 may synchronize directly with AP 1 (110) while FTM Responder 104 may synchronize with AP 2 (120). In an alternatively embodiment, the APs may lead the synchronization step.

Once synchronized, the FTM Responder can be available for incoming requests only part of the time or during periodic time windows. In one embodiment, the Governing AP performs some of the FTM Responder's tasks on its behalf. The Requesting STA may be unaware that it is performing a procedure with the Governing AP and not with the FTM Responder. In certain embodiments, the actual measurements which the initiating STA (interchangeably, User Equipment (UE)) can use to calculate the distance from the FTM Responder, is performed with the FTM Responder during its available time window.

Certain disclosed embodiment allow implementation of devices which augment connectivity WLAN to provide location coverage without the need to be connected to the electrical grid or to be powered by conventional Power Over Ethernet (POE). The disclosed embodiments greatly reduce the initial installation and operation cost while using the existing IEEE 802.11 FTM standard. In addition, the disclosed embodiments enable extending FTM range measurement to the Internet Of Things (IOT) device class as many of those applications are power conscious devices.

In certain implementations the client Initiating STA need not be aware of synchronization between the Governing AP and the FTM Responder. When an Initiating STA decides to initiate a procedure with the FTM Responder, the Governing AP may engage in the set-up procedure. While other FTM procedures are well within the scope of the disclosed principles, for brevity the following three procedures are discussed below: Passive Scan, Active Scan and FTM Procedures.

Two exemplary implementation of passive scan and active scan are disclosed as exemplary embodiments. Method 1.1 can be implemented without modification to the IEEE 802.11REVmc_D (January 2015) Standard or affecting the initiating device's implementation. Active and passive scans under method 1.1 are summarized below.

Active Scan—An exemplary active scan relies on the FTM Responder to monitor the medium for Probe Request messages and respond in a timely manner. In certain disclosed embodiments, the Governing AP takes the responsibility to monitor for these messages (i.e., actively monitor the medium) and respond as if it was the FTM Responder. Governing AP may use the FTM Responder's MAC Address (i.e., BSSID) to facilitate this pretense. The process may be entirely transparent to the Initiating STA.

Passive Scan—An exemplary passive scan relies on the FTM Responder to transmit a beacon message periodically. In order to maintain coherency with the Active Scan, in one embodiment, the Governing AP takes this responsibility by transmitting beacon messages periodically.

In contrast, Method 1.2 requires modifying the conventional IEEE Standard and the user implementation. Under method 1.2 and consistent with certain disclosed embodiments, the Initiating STA is prevented from using Active Scan which in turn would necessitate FTM Responder to be continually listening. This requirement may be implemented by programming the Initiating STA (UE) to not conduct active scans for FTM responders. In an exemplary embodiment, this may be done by the STA transmitting an FTM Request hoping a radio link. The STA may already have prior knowledge of its location as well as the AP/FTM Responder locations because of the Neighbor Report (discussed below) transmitted by other nearby APs or by Access NW Query Protocol (ANQP) or by using a L3/L4 protocol such as Secure User Plane Location (SUPL) protocol or other Application level protocols.

In one embodiment, the Initiating STA (UE) performs the FTM Procedure with the FTM Responder. The FTM procedure may be implemented directly between the Initiating STA and the FTM Responder. The direct implementation enables measuring physical (spatial) distance between the Initiating STA and the FTM Responder.

In an exemplary embodiment, the FTM procedure starts with the Initiating STA requesting an FTM procedure by sending an FTM Request message. Since the Initiating STA is not aware of the limited availability of the FTM Responders, the Governing AP assumes the responsibility of receiving and handling all such messages.

Conventional FTM discovery procedure require the Initiator STA to transmit an FTM request packet to an FTM Responder. The request packet includes a so-called ASAP mode setting which may be engaged (i.e., ASAP bit set to 1) for ASAP FTM procedure or disengaged (i.e., ASAP bit set to 0) for non-ASAP FTM Procedure. For ASAP-engaged FTM, the measurement procedure may be commenced immediately.

The disclosed embodiments include two methods for handling the FTM procedure. The first method (Method 2.1) for handling the FTM procedure works with non-ASAP FTM Requests (i.e., ASAP bit set to 0). If this method is employed, the Governing AP may signal that it does not accept ASAP mode (i.e., ASAP bit set to 1).

In the second exemplary method (Method 2.1), The Governing AP responds with FTM response with an allocation, instructing the Initiating STA when to execute or start the FTM procedure. This assignment takes into account the FTM Responder's availability pattern or available time window. By following the provided allocation, the Initiating STA can execute the FTM procedure directly with the FTM Responder. During the availability window, the FTM Responder will receive the FTM Request from the Initiating STA and proceed with an FTM Procedure.

The availability window may indicate start and end time of the FTM Responder's online availability. When the FTM Responder is unavailable, it may be disengaged (e.g., turned off or at deep sleep) to conserve energy. A portion of the availability window may be scheduled for a designated mobile device. For example, the first 3 msec. of a 10 msec. may be reserved (or scheduled) for a particular mobile device. Such scheduling information may also be communicated to a governing AP. The governing AP may be an FTM Responder.

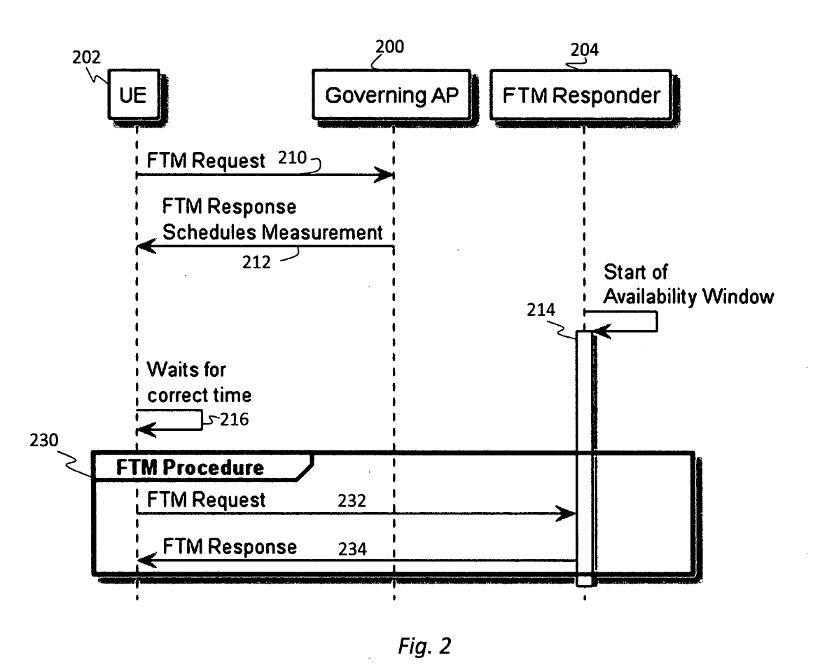

FIG. 2 illustrates an exemplary implementation of one embodiment of the disclosure. In FIG. 2, Governing AP 200 communicates with User Equipment (UE) 202 and FTM Responder 204. Here, the UE is the initiating STA. Governing AP 200 may comprise any conventional AP, router or Base Station (BSS) configured to implement the disclosed embodiments. In one exemplary embodiment, a governing AP comprises a conventional AP with software application (applet) to implement one or more of the disclosed methods. UE 202 may comprise a mobile device desiring to determine its location. As discussed below, the FTM Responder may comprise a processor in communication with a memory and radio platform configured to implement the disclosed embodiments.

At step 210, UE 202 transmits an FTM request to Governing AP 200. User Equipment 202 may issue the FTM request upon receiving advertisement (or beacon) indicating FTM procedure capability. The FTM advertisement may be broadcasted from Governing AP 200, from FTM Responder 204, from neighbor AP, from obtaining information of responder capable of FTM from ANQP protocol, from application level protocol such as HELD SUPL or from proprietary application level protocol.

In one embodiment, Governing AP 200 takes the responsibility to monitor for FTM Request messages by monitoring the communication medium and responds as if it was the FTM Responder. Governing AP 200 may use the FTM Responder's MAC Address (i.e., BSSID) to facilitate this pretense. In this manner, UE 202 may not know that it is conversing with Governing AP 200 instead of FTM Responder 204.

At step 212 Governing AP 200 sends an FTM response including schedule information for FTM measurement to UE 202. The schedule may indicate start of the availability window 214 for FTM Responder 204. The schedule information may also include duration of the time window or timeslot information within the time window during which UE 202 may submit an FTM request.

The FTM Procedure is schematically illustrated with box 230. At step 232, UE 202 transmits an FTM request to FTM Responder 204. The Governing AP BSSID and FTM Responder's BSSID may be different. In certain embodiments, the Governing AP may respond on behalf of the FTM Responder. To this end, the Governing AP may monitor more than only its own BSSID for incoming FTM requests.

As shown the FTM Responder's availability window opens at time 214. Thus, FTM responder 204 is available and engaged (i.e., ON) when FTM Request 232 is received. FTM response 234 is then transmitted to UE 202. This information may be used by UE 202 to determine FTM measurement(s). In FIG. 2, the ASAP mode is set to 0.

The second method according to the disclosed embodiment, (i.e., Method 2.2) may be more complex. The second method supports both the ASAP and the non-ASAP modes. In the ASAP mode, the first FTM response message may be received by User Equipment and may also be used for FTM/ToF estimation. In this embodiment, the FTM response message may be transmitted by FTM Responder 204 to UE 202.

In certain embodiments of the disclosure there may be a limit to the time it takes for the FTM Responder 204 to transmit signal 234. The limit may be predetermined. The limit may be for, example, 1 to 10 msec. In an exemplary embodiment of the disclosure, time window 2141 may be selected to be about 10-100 msec.

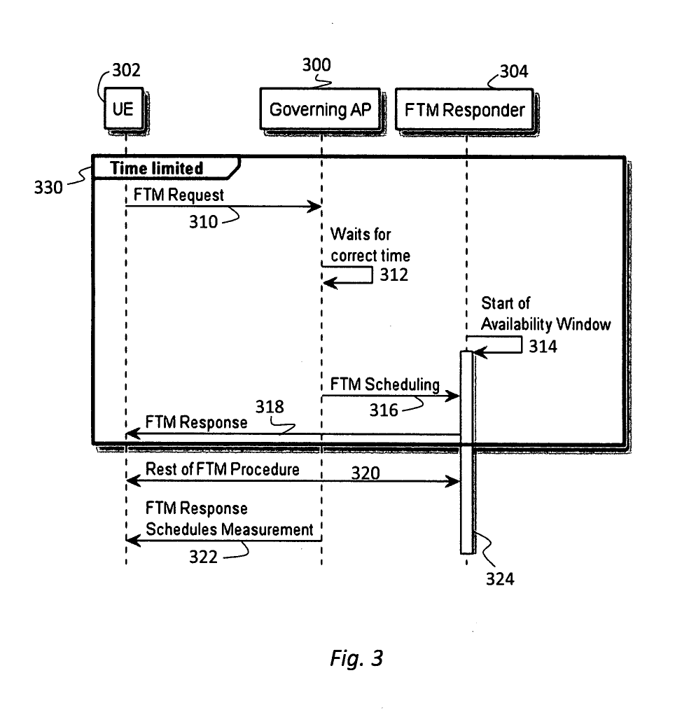

FIG. 3 illustrates an exemplary implementation of one embodiment of the disclosure for ASAP FTM measurements. Because the embodiment of FIG. 3 supports both ASAP and non-ASAP modes, the FTM request 310 may be used as both an FTM response request as well as for ToF calculation purposes. Moreover, for the time limit to be met, the FTM Responder must be notified by Governing AP 300 in a timely manner. Upon receipt of FTM request 310, Governing AP 300 waits for the correct time 312. The availability window of FTM Responder 304 start at time 314. Thus, Governing AP 300 awaits start of availability window 314 to send FTM scheduling request 316. In one embodiment, the FTM scheduling request 316 includes FTM Request 310 and/or information relating to the FTM Request (e.g., timestamp, etc.).

FTM Responder 304 sends FTM response 318 to UE 302. Thereafter, UE 302 and FTM Responder 304 communicate additional FTM Procedures and requirements pursuant to the IEEE 802.11 REVmc_D4 (January 2015) Standard, which is incorporated herein in its entirety for background information. In one embodiment of the disclosure Governing AP 300 transmits the scheduling message using the IEEE 802.11 Standard referenced above.

The FTM Responder needs to be listening for messages from AP in specific listening windows, which may be very small but need to be frequent enough to allow the ASAP time limit to be met. By way of example, for 2.4 GHz technology: The FTM Responder may be listening for 500 microsecond every 4 msec. That is, the FTM Responder may be listening only 12.5% of the time. The window may be short because FTM Responder 304 and Governing AP 300 are time synchronized.

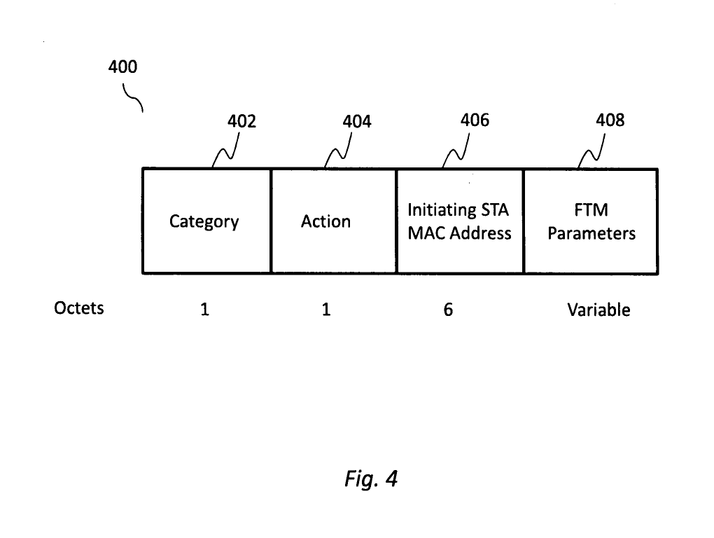

FIG. 4 shows an exemplary packet for carrying the scheduling message. Packet 400 includes category 402, action 404, Initiating STA MAC address 406 and FTM Parameters 408. These fields are exemplary and other fields may be included without departing from the disclosed principles. The Category field 402 is set to the value for Public as defined in Section 8.6.8.1 of the IEEE 802.11 REVmc_D4 (January 2015) Standard. Action field 404 indicates the action to be taken with respect to the frame. Initiating STA MAC address field 406 indicates the Medium Access Control (MAC) address for the initiating STA. FTM Parameters field 408 may be optionally present and it may include various parameters relating to the FTM measurement. It should be noted that packet 400 is abbreviated for illustration purposes. It should be noted that packet 400 contains exemplary segments and additional data segments may be added without departing from the disclosed principles.

Referring again to FIG. 3, in an exemplary embodiment of the disclosure out-of-band signaling may be used to communicate between Governing AP 300 and FTM Responder 304. The out-of-band signaling may help communicate FTM Request 310 earlier while maintaining low energy usage profile. The out-of-band signaling may be something other than IEEE 802.11 REVmc_D4 (January 2015) standard.

In still another embodiment of the disclosure, a wired backhaul may be used to physically connect Governing AP 300 and FTM Responder 304. The physical connection, while more costly, enables immediate communication between Governing AP 300 and FTM Responder 304. Also, the FTM Responder 304 may remain in Deep Sleep or Off modes while it is inactive to thereby conserve energy.

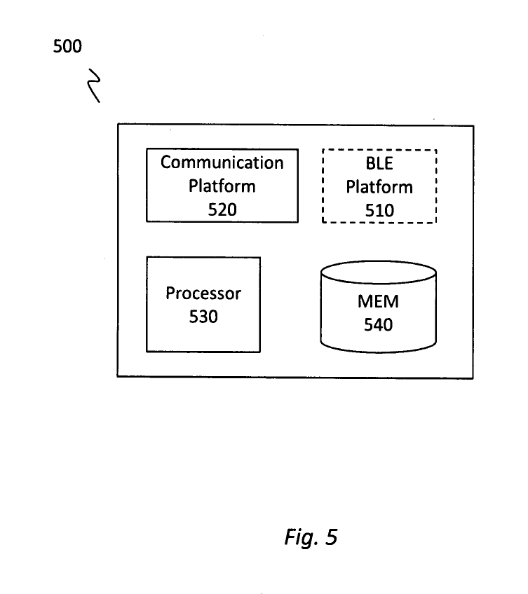

FIG. 5 shows an exemplary apparatus according to one embodiment of the disclosure. Specifically, apparatus 500 may comprise an FTM Responder according to one embodiment of the disclosure. FTM Responder 500 may be configured to conserve energy. In one embodiment, FFM Responder 500 may be configured to be available during predefined time windows. Apparatus 500 may engage an AP (not shown) while deployed in the field. To this end, FTM Responder 500 includes communication platform 520. Communication platform 520 may comprise one or more radio (including antenna) adapted to work with IEEE 802.11 communication modes. FTM Responder 500 may optionally include BLE platform 510. BLE signaling is significantly less energy intensive than WiFi, WiGig, cellular and other conventional communication modes.

The FTM Responder 500 may comprise hardware, software or a combination of hardware and software. Processor 530 may include processing circuitry to control communication functions as well as FTM functions of FTM Responder 500. For example, processor 530 may include a controller circuitry for receiving communication from the communication platform(s) and to engage in an FTM Procedure when requested. The processing circuitry may further be configured to identify one or more FTM Responders proximal to a communicating mobile device (not shown) seeking to determine its location.

Memory 540 may include instructions directing processor 530 to engage one or more of the desired functions. The functions may include, for example, directing apparatus 500 to go to power save (e.g., deep sleep or Off modes) when not active and to wake up during the availability window. Similarly, the instruction may direct processor 530 negotiate FTM procedures over radio platform 520. The instructions may further direct processor 530 to awaken outside of the availability window if required by a Governing AP. The instructions may further enable FTM Responder 500 to operate in both communication platforms 510 and 520. While not shown apparatus 500 may include an internal power source such as a battery or a capacitor. Alternatively, FTM Responder 500 may be configured to operate with an external power source.

In another exemplary embodiment, memory 540 may include non-transitory instructions that when executed cause the processor circuitry to: time synchronize with one or more FTM Responders, identify a first availability window for at least one FTM Responder, receive an FTM Request from the mobile device seeking to determine its location, and instruct the mobile device to transmit an FTM request to the at least one FTM Responder during the first availability window. The FTM Responders may also communicate updated availability windows to the Governing AP. The Governing AP may update the memory to included updated information.

The availability window for more than one FTM Responder may be provided. These availability windows may be staggered enabling the UE to communicate with multiple FTM Responders sequentially. In addition, an availability window may include a dedicated time window. For example, a first FTM Responder my reserve a segment of its availability window for an identified UE. Thus, the UE may be advised to communicate with the first FTM Responder during the specifically-allotted time window. The specifically-allotted time window may be scheduled for a given UE. When several FTM Responders are available, the UE may receive an availability scheduled for all the FTM Responders. The availability schedule may include timeslots for contacting each individual FTM Responder.

The following non-limiting and exemplary embodiments are presented to illustrate different embodiments of the disclosure. Example 1 is directed to a Governing Access Point (AP), comprising: a communication platform to receive one or more Fine Timing Measurement (FTM) request from a mobile device; a processor circuitry; and a memory circuitry in communication with the processor circuitry, the memory circuitry comprising instructions that when executed cause the processor circuitry to: time synchronize with one or more FTM Responders, identify a first availability window for at least one FTM Responder, receive an FTM Request from the mobile device seeking to determine proximity, and instruct the mobile device to transmit an FTM request to the at least one FTM Responder during the first availability window.

Example 2 is directed to the Governing AP of example 1, wherein the processor circuitry is further configured to identify a plurality of FTM Responders accessible to the mobile device.

Example 3 is directed to the Governing AP of any preceding example, wherein the instructions further cause the processor circuitry to actively monitor a communication medium for a probe request message from the mobile device and respond to the mobile device as a designated FTM Responder.

Example 4 is directed to the Governing AP of any preceding example, wherein the instructions further cause the processor circuitry to communicate a plurality of availability windows to the mobile device, each availability window corresponding to one of the plurality of identified FTM Responders.

Example 5 is directed to the Governing AP of any preceding example, wherein the instructions further cause the processor circuitry to transmit an FTM scheduling message to the at least one FTM Responder during the first availability window.

Example 6 is directed to the Governing AP of any preceding example, wherein the instructions further cause the processor to direct the at least one FTM Responder to transmit a first FTM response message to the mobile device.

Example 7 is directed to the Governing AP of any preceding example, wherein the instructions further cause the processor circuitry to schedule a plurality of availability windows for the at least one FTM Responder and to communicate the plurality of availability windows to the at least one FTM Responder.

Example 8 is directed to a non-transitory machine-readable medium comprising instruction executable by a processor circuitry to perform steps to determine proximity of a mobile device, the instructions direct the processor to: time synchronize one or more FTM Responders; identify a first availability window for at least one FTM Responder; receive an FTM Request from a mobile device seeking to determine proximity, and instruct the mobile device to transmit an FTM request to the at least one FTM Responder during the first availability window.

Example 9 is directed to the medium of any preceding example, wherein the processor circuitry is further configured to identify a plurality of FTM Responders accessible to the mobile device.

Example 10 is directed to the medium of any preceding example, wherein the instructions further cause the processor circuitry to actively monitor a communication medium for a probe request message from the mobile device and respond to the mobile device as a designated FTM Responder.

Example 11 is directed to the medium of any preceding example, wherein the instructions further cause the processor circuitry to communicate a plurality of availability windows to the mobile device, each availability window corresponding to one of the plurality of identified FTM Responders.

Example 12 is directed to the medium of any preceding example, wherein the instructions further cause the processor circuitry to transmit an FTM scheduling message to the at least one FTM Responder during the first availability window.

Example 13 is directed to the medium of any preceding example, wherein the instructions further cause the processor circuitry to direct the at least one FTM Responder to transmit a first FTM response message to the mobile device.

Example 14 is directed to the medium of any preceding example, wherein the instructions further cause the processor circuitry to schedule a plurality of availability windows for the at least one FTM Responder and to communicate the plurality of availability windows to the at least one FTM Responder.

Example 15 is directed to FTM Responder, comprising: a communication platform to receive one or more Fine Timing Measurement (FTM) request; a processor circuitry; and a memory circuitry in communication with the processor circuitry, the memory circuitry comprising instructions that when executed cause the processor circuitry to: time synchronize with an Access Point (AP), schedule a start time and an end time for at least one availability window, receive an FTM Request during the at least one availability window, respond to the mobile device with an FTM response during the availability window, and disengage the FTM Responder at the end of the availability window.

Example 16 is directed to the FTM Responder of any preceding example, wherein the communication platform is configured to receive the FTM request from one of the mobile device or the AP.

Example 17 is directed to the FTM Responder of any preceding example, wherein the instructions further cause the processor circuitry to disengage to conserve energy.

Example 18 is directed to the FTM Responder of any preceding example, wherein the instructions further cause the processor circuitry to communicate an FTM response to a mobile device seeking proximity determination.

Example 19 is directed to the FTM Responder of any preceding example, wherein the instructions further cause the processor circuitry to communicate FTM procedure directly to the mobile device.

Example 20 is directed to the FTM Responder of any preceding example, wherein the FTM request is received at the AP and relayed to the FTM Responder.

Example 21 is directed to the FTM Responder of any preceding example, wherein the instructions further cause the processor circuitry to use information contained in the FTM Request to determine proximity of the mobile device.

Example 22 is directed to the FTM Responder of any preceding example, wherein the instructions further cause the processor circuitry to communicate availability schedule to one or more of the AP or the mobile device.

Example 23 is directed to a non-transitory machine-readable medium comprising instruction executable by a processor circuitry to perform steps to determine proximity of a mobile device, the instructions direct the processor to: time synchronize with an Access Point (AP); schedule a start time and an end time for at least one availability window; communicate the at least one availability window to an Access Point (AP) to relay to the mobile device; receive an FTM request during the at least one availability window, the FTM request received directly from one of the mobile device or the AP; respond to the mobile device with an FTM response during the availability window; and disengage the FTM Responder at the end of the availability window.

Example 24 is directed to the medium of any preceding example, wherein the instructions further cause the processor to communicate FTM procedure directly to the mobile device.

Example 25 is directed to the medium of any preceding example, wherein the instructions further cause the processor to use information received at the AP for FTM measurement.

Example 26 is directed to the medium of any preceding example, wherein the FTM request is received at the AP and relayed to the FTM Responder.

Example 27 is directed to the medium of any preceding example, wherein the instructions further cause the processor to use information contained in the FTM Request to determine proximity of the mobile device.

Example 28 is directed to a Governing Access Point (AP) to determine proximity of a mobile device, comprising: means for time-synchronization with one or more FTM Responders; means for identifying a first availability window for at least one FTM Responder; means for receiving an FTM Request from a mobile device seeking to determine proximity, and means for instructing the mobile device to transmit an FTM request to the at least one FTM Responder during the first availability window.

Example 29 is directed to the Governing AP of any preceding example, further comprising means to identify a plurality of FTM Responders accessible to the mobile device.

Example 30 is directed to the Governing AP of any preceding example, further comprising means to actively monitor a communication medium for a probe request message from the mobile device and means for responding to the mobile device as a designated FTM Responder.

Example 31 is directed to the Governing AP of any preceding example, further comprising means for communicating a plurality of availability windows to the mobile device, each availability window corresponding to one of the plurality of identified FTM Responders.

Example 32 is directed to the Governing AP of any preceding example, further comprising means for transmitting an FTM scheduling message to the at least one FTM Responder during the first availability window.

Example 34 is directed to the Governing AP of any preceding example, further comprising means to direct the at least one FTM Responder to transmit a first FTM response message to the mobile device.

Example 35 is directed to the Governing AP of any preceding example, further comprising means for scheduling a plurality of availability windows for the at least one FTM Responder and means for communicating the plurality of availability windows to the at least one FTM Responder.

While the principles of the disclosure have been illustrated in relation to the exemplary embodiments shown herein, the principles of the disclosure are not limited thereto and include any modification, variation or permutation thereof.

What is claimed is:

1. A Governing Access Point (AP), comprising:
a communication platform to receive one or more Fine Timing Measurement (FTM) request from a mobile device;
a processor circuitry; and
a memory circuitry in communication with the processor circuitry, the memory circuitry comprising instructions that when executed cause the processor circuitry to:
time synchronize with one or more FTM Responders,
identify a first availability window for at least one FTM Responder,
receive an FTM Request from the mobile device seeking to determine proximity, and
instruct the mobile device to transmit an FTM request to the at least one FTM Responder during the first availability window.

2. The Governing AP of claim 1, wherein the processor circuitry is further configured to identify a plurality of FTM Responders accessible to the mobile device.

3. The Governing AP of claim 2, wherein the instructions further cause the processor circuitry to actively monitor a communication medium for a probe request message from the mobile device and respond to the mobile device as a designated FTM Responder.

4. The Governing AP of claim 2, wherein the instructions further cause the processor circuitry to communicate a plurality of availability windows to the mobile device, each availability window corresponding to one of the plurality of identified FTM Responders.

5. The Governing AP of claim 1, wherein the instructions further cause the processor circuitry to transmit an FTM scheduling message to the at least one FTM Responder during the first availability window.

6. The Governing AP of claim 1, wherein the instructions further cause the processor to direct the at least one FTM Responder to transmit a first FTM response message to the mobile device.

7. The Governing AP of claim 1, wherein the instructions further cause the processor circuitry to schedule a plurality of availability windows for the at least one FTM Responder and to communicate the plurality of availability windows to the at least one FTM Responder.

8. A non-transitory machine-readable medium comprising instruction executable by a processor circuitry to perform steps to determine proximity of a mobile device, the instructions direct the processor to:
time synchronize one or more FTM Responders;
identify a first availability window for at least one FTM Responder;
receive an FTM Request from a mobile device seeking to determine proximity, and
instruct the mobile device to transmit an FTM request to the at least one FTM Responder during the first availability window.

9. The medium of claim 8, wherein the processor circuitry is further configured to identify a plurality of FTM Responders accessible to the mobile device.

10. The medium of claim 9, wherein the instructions further cause the processor circuitry to actively monitor a communication medium for a probe request message from the mobile device and respond to the mobile device as a designated FTM Responder.

11. The medium of claim 9, wherein the instructions further cause the processor circuitry to communicate a plurality of availability windows to the mobile device, each availability window corresponding to one of the plurality of identified FTM Responders.

12. The medium of claim 8, wherein the instructions further cause the processor circuitry to transmit an FTM scheduling message to the at least one FTM Responder during the first availability window.

13. The medium of claim 8, wherein the instructions further cause the processor circuitry to direct the at least one FTM Responder to transmit a first FTM response message to the mobile device.

14. The medium of claim 8, wherein the instructions further cause the processor circuitry to schedule a plurality of availability windows for the at least one FTM Responder and to communicate the plurality of availability windows to the at least one FTM Responder.

15. An FTM Responder, comprising:
a communication platform to receive one or more Fine Timing Measurement (FTM) request;
a processor circuitry; and
a memory circuitry in communication with the processor circuitry, the memory circuitry comprising instructions that when executed cause the processor circuitry to:
time synchronize with an Access Point (AP),
schedule a start time and an end time for at least one availability window,
receive an FTM Request during the at least one availability window,
respond to the mobile device with an FTM response during the availability window, and
disengage the FTM Responder at the end of the availability window.

16. The FTM Responder of claim 15, wherein the communication platform is configured to receive the FTM request from one of the mobile device or the AP.

17. The FTM Responder of claim 15, wherein the instructions further cause the processor circuitry to disengage to conserve energy.

18. The FTM Responder of claim 15, wherein the instructions further cause the processor circuitry to communicate an FTM response to a mobile device seeking proximity determination.

19. The FTM Responder of claim 15, wherein the instructions further cause the processor circuitry to communicate FTM procedure directly to the mobile device.

20. The FTM Responder of claim 15, wherein the FTM request is received at the AP and relayed to the FTM Responder.

21. The FTM Responder of claim 20, wherein the instructions further cause the processor circuitry to use information contained in the FTM Request to determine proximity of the mobile device.

22. The FTM Responder of claim 15, wherein the instructions further cause the processor circuitry to communicate availability schedule to one or more of the AP or the mobile device.

23. A non-transitory machine-readable medium comprising instruction executable by a processor circuitry to perform steps to determine proximity of a mobile device, the instructions direct the processor to:
time synchronize with an Access Point (AP);
schedule a start time and an end time for at least one availability window;
communicate the at least one availability window to an Access Point (AP) to relay to the mobile device;
receive an FTM request during the at least one availability window, the FTM request received directly from one of the mobile device or the AP;
respond to the mobile device with an FTM response during the availability window; and
disengage the FTM Responder at the end of the availability window.

24. The medium of claim 23, wherein the instructions further cause the processor to communicate FTM procedure directly to the mobile device.

25. The medium of claim 23, wherein the instructions further cause the processor to use information received at the AP for FTM measurement.

26. The medium of claim 23, wherein the FTM request is received at the AP and relayed to the FTM Responder.

27. The medium of claim 26, wherein the instructions further cause the processor to use information contained in the FTM Request to determine proximity of the mobile device.
